(19) United States
(12) Patent Application Publication
(10) Pub. No.: US 2017/0080950 A1
(43) Pub. Date: Mar. 23, 2017

(54) METHOD AND DEVICE FOR OPERATING A VEHICLE

(71) Applicant: Robert Bosch GmbH, Stuttgart (DE)

(72) Inventors: Oliver Pink, Stuttgart (DE); Carsten Hasberg, llsfeld-Auenstein (DE); Stefan Nordbruch, Kornwestheim (DE)

(21) Appl. No.: 15/126,447

(22) PCT Filed: Jan. 23, 2015
(86) PCT No.: PCT/EP2015/051328

§ 371 Date: Sep. 15, 2016

(30) Foreign Application Priority Data
Mar. 20, 2014 (DE) 10 2014 205 180.0

(51) Int. Cl. B60W 50/00; B60W 40/02

(52) U.S. Cl. CPC B60W 50/0098; B60W 40/02

(57) ABSTRACT

A method for operating a vehicle having a plurality of environmental sensors for acquiring a surrounding environment of the vehicle, including acquiring a surrounding environment of the vehicle using each of the environmental sensors, ascertaining of object data, corresponding to objects, for each environmental sensor, based on the raw data of the corresponding environmental sensor, fusion of the respective object data of the environmental sensors with one another, so that fused object data are ascertained, fusion of the respective raw data of the environmental sensors with one another, so that fused raw data are ascertained, ascertaining of raw object data, corresponding to objects, based on the fused raw data, comparison with one another of the fused object data and the raw object data, controlling of at least one vehicle system as a function of the comparison. A device for operating a vehicle and a computer program are also described.

### FIELD

The present invention relates to a method and to a device for operating a vehicle. The present invention also relates to a computer program.

### BACKGROUND INFORMATION

German Patent Application No. DE 101 33 945 A1 describes a method and a device for the exchanging of and for the common processing of object data between sensors and a processing unit, position information and/or speed information and/or further object attributes of sensor objects and fusion objects being transmitted and processed.

### SUMMARY

An object of the present invention is to provide a method for operating a vehicle, the vehicle having a plurality of environmental sensors for acquiring a surrounding environment of the vehicle.

The object of the present invention can also be seen as the provision of a device for operating a vehicle.

The object of the present invention can in addition be seen as providing a computer program.

Advantageous embodiments of the present invention are described herein.

According to an aspect of the present invention, a method is provided for operating a vehicle, the vehicle having a plurality of environmental sensors for acquiring a surrounding environment of the vehicle, including the following steps:
acquiring a surrounding environment of the vehicle using each of the environmental sensors, so that the environmental sensors each provide raw data that correspond to the surrounding environment acquired by the corresponding environmental sensor,
ascertaining of object data, corresponding to objects, for each environmental sensor, based on the raw data of the corresponding environmental sensor,
fusion of the respective object data of the environmental sensors with one another, so that fused object data are ascertained,
fusion of the respective raw data of the environmental sensors with one another, so that fused raw data are ascertained,
ascertaining of raw object data, corresponding to objects, based on the fused raw data,
comparison with one another of the fused object data and the raw object data,
controlling of at least one vehicle system as a function of the comparison.

According to a further aspect, a device is provided for operating a vehicle, including:
a plurality of environmental sensors for acquiring a surrounding environment of the vehicle,
the environmental sensors being fashioned respectively to provide raw data that correspond to the surrounding environment acquired by the corresponding environmental sensor,
a processing device that is fashioned to carry out the steps of ascertaining, fusion, and comparing according to the method of the present invention, and
a control device for controlling at least one vehicle system as a function of the comparison.

According to another aspect of the present invention, a computer program is provided that includes program code for carrying out the method according to the present invention when the computer program is executed on a computer, in particular a processing device.

According to a further aspect of the present invention, a vehicle is provided that includes the device according to the present invention.

The present invention thus includes in particular both carrying out an object-based fusion of sensor objects and also of fusing raw data of the environmental sensors with one another, in order to ascertain, based on the fused raw data, raw object data that correspond to objects. The results of these two methods, i.e., the object-based fusion and the raw data fusion with subsequent ascertaining of the raw object data, are compared with one another according to the present invention, so that for example errors that may be present can advantageously be recognized in one of the methods or in one of the method steps. As a function of the comparison, at least one vehicle system of the vehicle is then advantageously controlled. Thus, a redundancy is advantageously created, because object data, i.e., the fused object data and the raw object data, are ascertained in two different ways. Thus, decisions regarding the controlling of the vehicle system can be secured, in particular can be better secured, in the case of an agreement, in particular within a specified error tolerance range. If both the fused object data and also the raw object data are within a specified error tolerance range, then, generally, it can be assumed that objects corresponding to these fused object data and raw object data are also actually present at the real locations in the surrounding environment of the vehicle.

An environmental sensor in the sense of the present invention includes in particular a passive and/or an active measurement pickup or measurement probe, and a control device, assigned to this measurement pickup or measurement probe, that can for example be designated a sensor control device. The ascertaining can for example be carried out in the sensor control device.

According to a specific embodiment, the environmental sensors can have the same design, or for example can have different designs. An environmental sensor can for example be a video sensor, a radar sensor, an ultrasound sensor, a laser sensor, or a lidar sensor.

According to a specific embodiment, it can be provided that the controlling includes a controlling of a warning signal device for providing a warning signal to a driver of the vehicle, in such a way that a warning signal is provided when the fused object data and the raw object data have differences that are outside a specified error tolerance range.

The driver is thus advantageously warned that differences are present that are outside the specified error tolerance range. The driver can now for example advantageously correspondingly adapt his driving. The warning signal can for example be an optical, acoustic, or haptic warning signal. In particular, a plurality of warning signals can be provided that are for example the same, or preferably are different.

According to a further specific embodiment, it can be provided that the controlling includes a controlling of a driver assistance system of the vehicle, such that the driver assistance system provides a limited driver assistance function when the fused object data and the raw object data have differences that are outside a specified error tolerance range.

A limited functionality makes sense because a driver assistance system standardly relies on the object data and/or raw object data in making its decisions. A decision can for example be an answer to the following questions: May the vehicle pass? Is there an obstacle? Is the vehicle staying in its lane or not? However, because the differences are outside the specified error tolerance range, the object data and the raw object data are as a rule no longer reliable enough to safely provide the full functionality or the full scope of functionality.

Thus, for example, an automatic speed regulation device (also called ACC, Adaptive Cruise Control) will reduce its target speed, or will permit only those target speeds that are below a specified target speed threshold value. A driver assistance system that normally supports the driver during a passing maneuver will refuse to provide support during a passing maneuver if the differences are outside the specified error tolerance range. The driver thus relies completely on himself and has to carry out the passing maneuver himself. However, because the object data, i.e., in particular the fused object data and the raw object data, are no longer adequately reliable, in this way it is advantageously avoided that such a passing maneuver assistant makes no decisions or interventions in vehicle operation or vehicle guidance that can impair safety.

According to another specific embodiment, it can be provided that the controlling includes a controlling of a processing device in such a way that at least some of the data are discarded and newly ascertained if the fused object data and the raw object data have differences that are outside a specified error tolerance range.

Thus, a new calculation takes place, with a new chance that this time the differences will be within the specified error tolerance range, and it will thus be possible to regard the data as sufficiently reliable. Due to the discarding, there is also no longer the danger that the discarded data could otherwise possibly be used for other calculations, where they could lead to false results that could for example impair vehicle safety.

According to another specific embodiment, it can be provided that the ascertaining of the object data is carried out internally in the corresponding environmental sensor, which correspondingly provides the ascertained object data. The internal ascertaining can for example be carried out by an internal processing unit (i.e. internally in the environmental sensor).

In this way, the advantage is advantageously brought about that at least a part of the processing has already been accomplished. Thus, for the processing steps that still have to be carried out, only a correspondingly smaller computing capacity and/or storage capacity have to be provided.

According to a further specific embodiment, it can be provided that the environmental sensors provide their raw data externally, so that the ascertaining of the object data for each environmental sensor is carried out externally from the corresponding environmental sensor. The external ascertaining can for example be carried out using an external processing unit (i.e., externally from the environmental sensor).

In this way, the advantage is advantageously brought about that environmental sensors that internally cannot themselves ascertain the object data, because for example they do not have the computing capacity for this, can be used for the method according to the present invention and/or the device according to the present invention. Thus, older sensor models can also be used. In particular, older vehicles can be retrofitted.

According to a specific embodiment, it can be provided that the ascertaining of the object data is carried out both internally in the environmental sensors themselves and also externally from the environmental sensors. Externally, this may be done, for example, using a processing unit provided externally from the environmental sensors. Internally, this may be done, for example, using a processing unit provided internally in the environmental sensors.

In a specific embodiment, it can be provided that the fusion (i.e., in particular the fusion of the object data and/or the fusion of the raw data) and/or the ascertaining or specification of a specified error tolerance range includes an ascertaining of a quality level or a measure. The quality level or measure can for example be ascertained as a function of a position or location of the object. An object that is situated in an edge region relative to a center of the error tolerance range has a different measure than does an object situated relatively closer to the center. With the quality level or the measure, it is in particular indicated how reliable an ascertained or calculated result or value is. This is because ascertained or calculated results or values may have errors. The quality level or the measure thus correspond in particular to an error bar. The quality level or the measure can for example include a probability. That is, object data, i.e., in particular fused object data, including a quality level can make a statement concerning with what probability Z an object X is present at a particular location.

Specific embodiments regarding the method result from the corresponding specific embodiments regarding the device, and vice versa. Statements made in connection with the method hold analogously for the device, and vice versa.

According to a specific embodiment, it can be provided that the processing device includes a plurality of processing units for ascertaining the object data, the environmental sensors each including a processing unit, so that the environmental sensors can output the ascertained object data. These processing units can be designated as internal processing units, relative to the environmental sensors.

A processing unit can for example be a control device of the environmental sensor, or can be integrated in such a control device.

In a further specific embodiment, it can be provided that the processing device includes at least one processing unit for ascertaining the object data, the unit being provided externally from the environmental sensors, so that in order to ascertain the object data the environmental sensors can output their raw data to the at least one processing unit. This at least one processing unit can in particular be designated as an external processing unit, relative to the environmental sensors.

According to a specific embodiment, it can be provided that a plurality of vehicle systems are controlled as a function of the comparison. The vehicle systems can for example be fashioned identically, or preferably differently.

In the following, the present invention is explained in more detail on the basis of preferred exemplary embodiments.

### BRIEF DESCRIPTION OF THE DRAWINGS

FIG. 1 shows a device for operating a vehicle.

FIG. 2 shows a flow diagram of a method for operating a vehicle.

### DETAILED DESCRIPTION OF EXAMPLE EMBODIMENTS

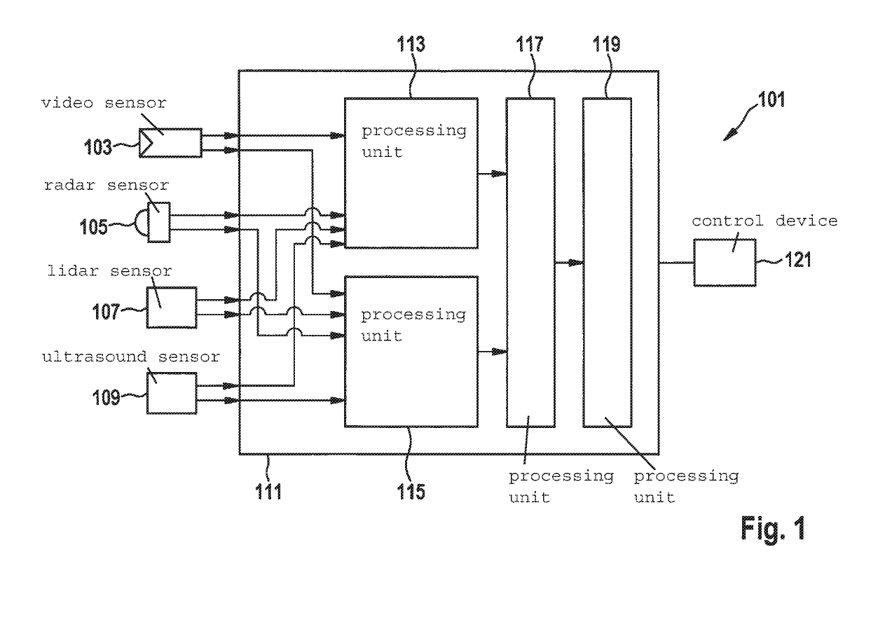

FIG. 1 shows a device 101 for operating a vehicle (not shown).

Device 101 includes a plurality of environmental sensors 103, 105, 107, and 109. For example, environmental sensor 103 can be a video sensor. Environmental sensor 105 can for example be a radar sensor. Environmental sensor 107 can for example be a lidar sensor. Environmental sensor 109 can for example be an ultrasound sensor. The four environmental sensors 103, 105, 107, and 109 are fashioned in each case to provide raw data that correspond to the surrounding environment acquired by the corresponding environmental sensor.

These raw data are provided to a processing device 111 that includes a plurality of processing devices 113, 115, 117, and 119. More precisely, the raw data of environmental sensors 103, 105, 107, and 109 are provided to processing unit 115. Processing unit 115 fuses the raw data of environmental sensors 103, 105, 107, and 109 with one another, so that fused raw data are ascertained. Based on the fused raw data, processing unit 115 ascertains raw object data corresponding to objects.

In environmental sensors 103, 105, 107, and 109 themselves, in each case object data corresponding to objects are internally ascertained for each environmental sensor based on the raw data of the corresponding environmental sensor. This is preferably carried out using respective processing units (not shown here) that are for example situated in each sensor control device. These processing units (not shown) are also included in processing device 111. These object data of the respective environmental sensors 103, 105, 107, and 109 are provided to a further processing unit 113 of processing device 111. Further processing unit 113 fusions the respective object data of environmental sensors 103, 105, 107, and 109 with one another, so that fused object data are ascertained.

Both the raw object data and the fused object data are provided to a further processing unit 117. This unit compares the fused object data and the raw object data with one another.

Device 101 further includes a control device 121 that is fashioned to control at least one vehicle system as a function of the comparison. That is, in particular, further processing unit 117 can provide the result of the comparison to control device 121. In the exemplary embodiment shown in FIG. 1, control device 121 is situated externally from processing device 109. In a specific embodiment that is not shown, it can for example be provided that control device 121 is integrated in processing device 111.

Processing device 111 has, in addition, a further processing unit 119 that can carry out additional calculations for example based on the comparison. Such calculations can for example include a fusion of the fused object data and the raw object data. The fusion of the fused object data and of the raw object data can for example be parameterized; i.e., a parameterized fusion. The parameterization is in particular based on the comparison, i.e., on a result of the comparison. In the case of a new calculation, for example other parameters can be used. The fusion of fused object data and the raw object data can for example calculate a quality level for the result of the fusion. A quality level can for example be a probability. That is, object data, i.e., in particular fused object data, including a quality level can make a statement concerning with what probability Z an object X is present at a particular location.

In a specific embodiment not shown, more than or fewer than four environmental sensors can be provided.

According to a specific embodiment, it can be provided that, based on the fused raw data, an environmental model is ascertained for the surrounding environment of the vehicle. This is done, in particular, using processing unit 115. In particular, a further environmental model is ascertained based on the fused object data. This is done, in particular, using processing unit 113. These two environmental models are compared to one another. This is done, in particular, using processing unit 117. This comparison of the two environmental models is in particular included by the step of comparing the fused object data and the raw object data with one another. If the two environmental models lie outside a specified error tolerance range, for example a new calculation can be provided of at least one of the two environmental models, preferably of both environmental models. The data on which the environmental models are based can for example be discarded.

An error tolerance range can for example include a specified number of objects that are not present both in the fused object data and in the raw object data. If for example according to the fused object data three objects are situated in the surrounding environment of the vehicle, but according to the raw object data six objects should be in the surrounding environment of the vehicle, then three objects are not present both in the fused object data and also in the raw object data. As a function of the concrete value of the specified number, this can have the result that there are differences (three objects) that are outside or within the error tolerance range (specified number). Thus, the specified number could for example be two. In this case, the differences are outside the specified error tolerance range. Thus, the specified number could for example be four. In this case, the differences are within the specified error tolerance range. It will be noted that the above values and object numbers are intended only for illustration, but are not limiting. Other values are possible, depending on the concrete individual case.

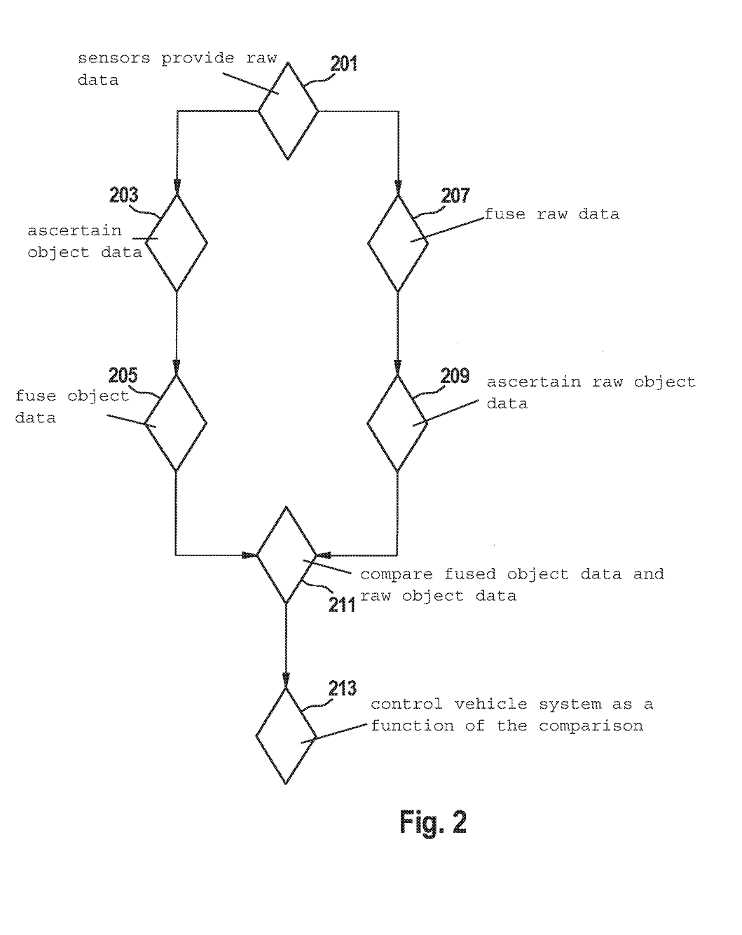

FIG. 2 shows a flow diagram of a method for operating a vehicle that has a plurality of environmental sensors for acquiring a surrounding environment of the vehicle.

According to a step 201, the plurality of environmental sensors each include a surrounding environment of the vehicle, so that the environmental sensors each provide raw data that correspond to the environment acquired by the corresponding environmental sensor. In a step 203, object data are ascertained for each environmental sensor based on the raw data of the corresponding environmental sensor, the object data corresponding to objects. In the step 205, the respective object data of the environmental sensors are fused with one another, so that fused object data are ascertained.

In a step 207, the respective raw data of the environmental sensors are fused with one another so that fused raw data are ascertained. In a step 209, raw object data corresponding to objects are ascertained based on the fused raw data.

In a step 211, the fused object data and the raw object data are compared to one another, so that according to a step 213 at least one vehicle system is controlled as a function of the comparison.

According to a specific embodiment that is not shown, it can be provided that a plurality of vehicle systems are controlled as a function of the comparison. The vehicle systems can for example be fashioned identically or preferably differently from one another.

1-10. (canceled)

11. A method for operating a vehicle that has a plurality of environmental sensors for acquiring a surrounding environment of the vehicle, the method comprising:
acquiring a surrounding environment of the vehicle using each of the environmental sensors, so that the environmental sensors each provide raw data that correspond to the surrounding environment acquired by the corresponding environmental sensor;
ascertaining of object data, corresponding to objects, for each environmental sensor, based on the raw data of the corresponding environmental sensor;
fusing the respective object data of the environmental sensors with one another, so that fused object data are ascertained;
fusing the respective raw data of the environmental sensors with one another, so that fused raw data are ascertained;
ascertaining raw object data, corresponding to objects, based on the fused raw data;
comparing with one another the fused object data and the raw object data;
controlling at least one vehicle system as a function of the comparison.

12. The method as recited in claim 11, wherein the controlling includes controlling of a warning signal device for providing a warning signal to a driver of the vehicle in such a way that a warning signal is provided when the fused object data and the raw object data have differences that are outside a specified error tolerance range.

13. The method as recited in claim 11, wherein the controlling includes controlling a driver assistance system of the vehicle in such a way that the driver assistance system provides a limited driver assistance function if the fused object data and the raw object data have differences that are outside a specified error tolerance range.

14. The method as recited in claim 11, wherein the controlling includes controlling a processing device in such a way that at least some of the data are discarded and newly ascertained if the fused object data and the raw object data have differences that are outside a specified error tolerance range.

15. The method as recited in claim 11, wherein the ascertaining of the object data is carried out internally in the corresponding environmental sensor, which correspondingly provides the ascertained object data.

16. The method as recited in claim 11, wherein the environmental sensors provide their raw data externally, so that the ascertaining of the object data for each environmental sensor is carried out externally from the corresponding environmental sensor.

17. A device for operating a vehicle, comprising:
a plurality of environmental sensors for acquiring a surrounding environment of the vehicle, the environmental sensors being fashioned respectively to provide raw data that correspond to the surrounding environment acquired by the corresponding environmental sensor;
a processing device that is fashioned to ascertain object data, corresponding to objects, for each of the environmental sensors, based on the raw data of the corresponding environmental sensor, fuse the respective object data of the environmental sensors with one another, so that fused object data are ascertained, fuse the respective raw data of the environmental sensors with one another, so that fused raw data are ascertained, and ascertain raw object data, corresponding to objects, based on the fused raw data, and compare with one another the fused object data and the raw object data; and
a control device for controlling at least one vehicle system as a function of the comparison.

18. The device as recited in claim 17, wherein the processing device includes a plurality of processing units for ascertaining the object data, the environmental sensors each include a processing unit, so that the environmental sensors can output the ascertained object data.

19. The device as recited in claim 17, wherein the processing device include at least one processing unit for ascertaining the object data that is provided externally from the environmental sensors, so that in order to ascertain the object data the environmental sensors can output their raw data to the at least one processing unit.

20. A non-transitory computer readable storage medium storing a computer program including program code for operating a vehicle that has a plurality of environmental sensors for acquiring a surrounding environment of the vehicle, the program code, when executed by a computer, causing the computer to perform:
acquiring a surrounding environment of the vehicle using each of the environmental sensors, so that the environmental sensors each provide raw data that correspond to the surrounding environment acquired by the corresponding environmental sensor;
ascertaining of object data, corresponding to objects, for each environmental sensor, based on the raw data of the corresponding environmental sensor;
fusing the respective object data of the environmental sensors with one another, so that fused object data are ascertained;
fusing the respective raw data of the environmental sensors with one another, so that fused raw data are ascertained;
ascertaining raw object data, corresponding to objects, based on the fused raw data;
comparing with one another the fused object data and the raw object data; and
controlling at least one vehicle system as a function of the comparison.
